(19) United States
(12) Patent Application Publication
(10) Pub. No.: US 2022/0159211 A1
(43) Pub. Date: May 19, 2022

(54) VIDEO PROCESSING APPARATUS, VIDEO PROCESSING METHOD, A NON-TRANSITORY COMPUTER READABLE MEDIUM, AND VIDEO PROCESSING SYSTEM

(71) Applicant: JVCKENWOOD Corporation, Yokohama-shi (JP)

(72) Inventor: Takashi ONODERA, Yokohama-shi (JP)

(21) Appl. No.: 17/587,943

(22) Filed: Jan. 28, 2022

Related U.S. Application Data
(63) Continuation of application No. PCT/JP2020/028988, filed on Jul. 29, 2020.

(30) Foreign Application Priority Data
Jul. 31, 2019 (JP) 2019-140705

(51) Int. Cl. H04N 5/445; H04N 5/272

(52) U.S. Cl. CPC H04N 5/44504; H04N 5/272

(57) ABSTRACT

According to one embodiment, a video processing apparatus includes: a video obtaining unit configured to obtain a video image taken by a video camera; a supplementary information reading unit configured to detect a supplementary information tag recorded in the video image obtained by the video obtaining unit, and read supplementary information in an additional information file; an additional information file obtaining unit configured to obtain the additional information file, based on the supplementary information read by the supplementary information reading unit; and an additional information generation unit configured to generate additional information from the additional information file obtained by the additional information file obtaining unit.

### CROSS REFERENCE TO RELATED APPLICATION

This application is based upon and claims the benefit of priority from Japanese patent application No. 2019-140705 filed on Jul. 31, 2019, the disclosure of which is incorporated herein in its entirety by reference.

### BACKGROUND

The present invention relates to a video processing apparatus, a video processing method, a program, and a video processing system.

In recent years, the demand for superimposing additional information on a video image taken using a video camera has been increasing. For example, Patent Literature 1 (Japanese Unexamined Patent Application Publication No. 2015-070423) discloses a technique of superimposing, on a video image, a bar code obtained by coding additional information, and of reading the bar code to thereby display the additional information on the video image.

As described above, the technique disclosed in Patent Literature 1 superimposes, on the video image, the bar code obtained by coding the additional information. However, the amount of information recordable in the bar code is limited. Accordingly, the amount of information about the additional information displayable on the video image is limited.

### SUMMARY

A video processing apparatus according to an aspect of this embodiment includes:

a video obtaining unit configured to obtain a video image taken by a video camera;

a supplementary information reading unit configured to detect a supplementary information tag recorded in the video image obtained by the video obtaining unit, and read supplementary information in an additional information file;

an additional information file obtaining unit configured to obtain the additional information file, based on the supplementary information read by the supplementary information reading unit; and

an additional information generation unit configured to generate additional information from the additional information file obtained by the additional information file obtaining unit.

A video processing method according to an aspect of this embodiment includes:

a step of obtaining a video image taken by a video camera;

a step of detecting a supplementary information tag recorded in the obtained video image, and reading supplementary information in an additional information file;

a step of obtaining the additional information file, based on the read supplementary information; and

a step of generating additional information from the obtained additional information file.

A program according to an aspect of this embodiment causes a computer to execute:

a step of obtaining a video image taken by a video camera;

a step of detecting a supplementary information tag recorded in the obtained video image, and reading supplementary information in an additional information file;

a step of obtaining the additional information file, based on the read supplementary information; and

a step of generating additional information from the obtained additional information file.

A video processing system according to an aspect of this embodiment is

a video processing system including a supplementary information tag display apparatus, and a video processing apparatus, wherein

the supplementary information tag display apparatus includes
a display unit configured to display a supplementary information tag so as to allow a video camera to image the tag, the supplementary information tag including supplementary information in an additional information file,

the video processing apparatus includes:
a video obtaining unit configured to obtain a video image taken by the video camera;
a supplementary information reading unit configured to detect the supplementary information tag recorded in the video image obtained by the video obtaining unit, and read the supplementary information in the additional information file;
an additional information file obtaining unit configured to obtain the additional information file, based on the supplementary information read by the supplementary information reading unit; and
an additional information generation unit configured to generate additional information from the additional information file obtained by the additional information file obtaining unit, and

the supplementary information tag is recorded in the video image, by imaging the supplementary information tag output on the display unit when the video camera takes the video image.

### BRIEF DESCRIPTION OF THE DRAWINGS

FIG. 1 is an overall diagram showing the configuration of a video processing system according to a first embodiment.

FIG. 2 is a block diagram showing the configuration of the video processing apparatus and the peripheral configuration according to the first embodiment.

FIG. 3 is a sequence chart showing one operation example during video imaging by the video processing system according to the first embodiment.

FIG. 4 is a sequence chart showing one operation example during video reproduction by the video processing system according to the first embodiment.

FIG. 5 is a block diagram showing the configuration of the video processing apparatus and the peripheral configuration according to a second embodiment.

FIG. 6 is a sequence chart showing one operation example during video output by the video processing system according to the second embodiment.

FIG. 7 is an overall diagram showing the configuration of a video processing system according to a third embodiment.

FIG. 8 is a block diagram showing the configuration of a supplementary information tag display apparatus and the peripheral configuration according to the third embodiment.

FIG. 9 is a block diagram showing the configuration of the video processing apparatus and the peripheral configuration according to the third embodiment.

FIG. 10 is a sequence chart showing one operation example during video imaging by the video processing system according to the third embodiment.

FIG. 11 is a sequence chart showing one operation example during video reproduction by the video processing system according to the third embodiment.

### DETAILED DESCRIPTION

Hereinafter, referring to the drawings, embodiments of the present invention are described. Note that the following description and drawings are appropriately omitted and simplified for the sake of clarifying the description. In the following drawings, the same elements are assigned the same symbols. Redundant description is omitted as required. Specific numerical value and the like described below are only examples for facilitating understanding of the invention. There is no limitation thereto.

### First Embodiment

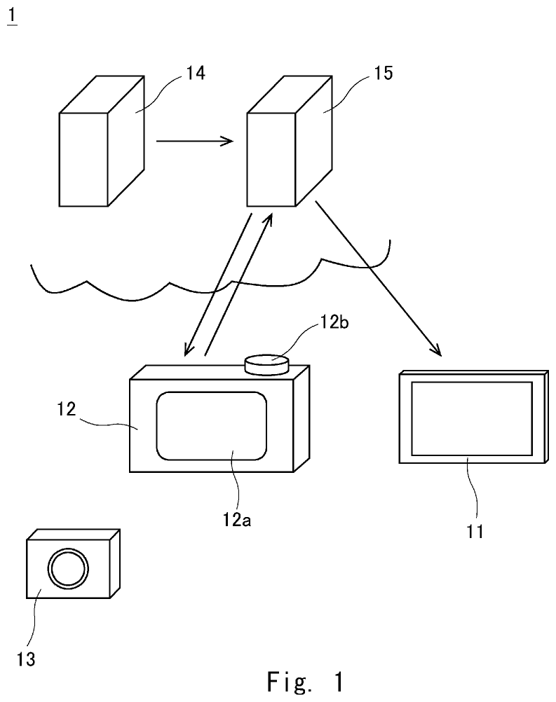

First, referring to FIG. 1, the configuration of a video processing system according to a first embodiment is described. FIG. 1 is an overall diagram showing the configuration of the video processing system according to the first embodiment. As shown in FIG. 1, the video processing system 1 includes a video processing apparatus 11, a supplementary information tag display apparatus 12, a video camera 13, an additional information data server 14, and an additional information file generation server 15. The supplementary information tag display apparatus 12 includes a display unit 12a, and a trigger 12b.

The video processing system 1 is a system that can reproduce a video combined with additional information generated by superimposing additional information on a video image taken using the video camera 13. The additional information is information viewable by the user. The additional information is, for example, subtitles. The additional information may be information that defines visual representation, and a text structure using a markup language, such as HTML (HyperText Markup Language). Use of a markup language, such as HTML, as the additional information, can generate a video combined with additional information having higher representational power, in comparison with use of subtitles.

The additional information file generation server 15 generates an additional information file, based on an instruction by the supplementary information tag display apparatus 12. Specifically, when the trigger 12b is operated by a user, not shown, the additional information file generation server 15 starts to generate an additional information file. The additional information file is a file that includes additional information. The additional information file generation server 15 is connected to the additional information data server 14, and can receive additional information data. The additional information file generation server 15 generates and saves the additional information file, based on the received additional information data. The additional information file generation server 15 generates a supplementary information tag from supplementary information in the additional information file, and transmits the tag to the supplementary information tag display apparatus 12.

The supplementary information is information supplied to the additional information file. Specifically, the supplementary information includes, for example, a location where the additional information file is present, the name of the additional information file, and the file format of the additional information file. The supplementary information tag is obtained by codifying the supplementary information or converting the supplementary information into a signal. The supplementary information tag is, for example, obtained by codifying the URL (Uniform Resource Locator) of the additional information file or by converting this URL into a signal. The supplementary information tag may further include information about a method of accessing the additional information file. The information about the method of accessing the additional information file is, for example, a method of accessing the additional information file generation server 15, a login name, and a password.

The supplementary information tag transmitted from the additional information file generation server 15 is displayed on the display unit 12a included in the supplementary information tag display apparatus 12, in a manner allowing the video camera 13 to image the tag. The supplementary information tag may have any format only if the video camera 13 can image the tag. The supplementary information tag is, for example, a video, such as a two-dimensional code, a bar code, or a character string. In a case where the supplementary information tag is a video, the display unit 12a is, for example, a display that can display the video.

The supplementary information tag may be an audio signal, such as DTMF (Dual-Tone Multi-Frequency) or an audio watermark. In a case where the supplementary information tag is an audio signal, the display unit 12a is, for example, a speaker that can output the audio signal. The supplementary information tag may be an optical signal that uses visual light or infrared light. In a case where the supplementary information tag is an optical signal, the display unit 12a is, for example, a light-emitting diode capable of outputting an optical signal.

The video camera 13 records the supplementary information tag in the video image, by imaging the supplementary information tag displayed on the display unit 12a when taking the video image. The video processing apparatus 11 captures the video image file taken by the video camera 13, superimposes the additional information on the video image file, and generates a video file combined with the additional information.

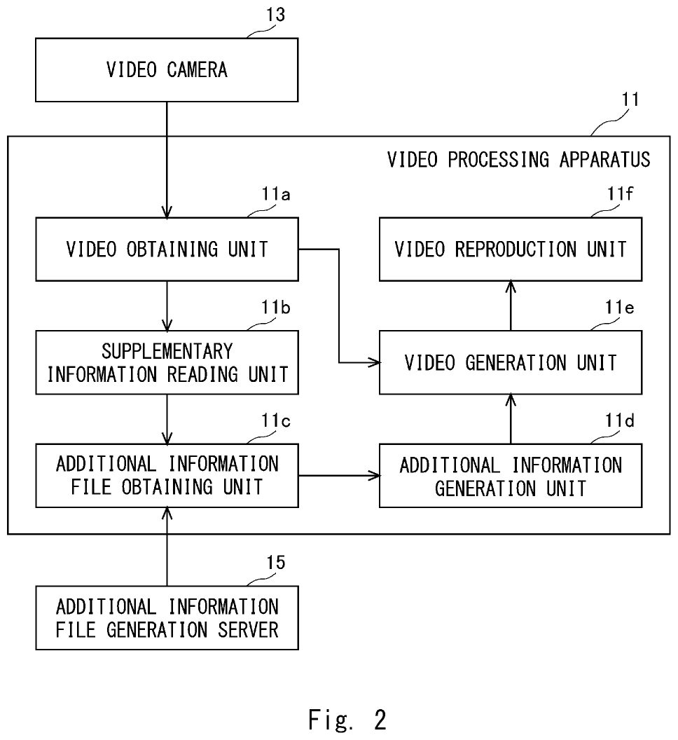

Referring to FIG. 2, the configuration of the video processing apparatus 11 is described. FIG. 2 is a block diagram showing the configuration of the video processing apparatus and the peripheral configuration according to the first embodiment. As shown in FIG. 2, the video processing apparatus 11 includes a video obtaining unit 11a, a supplementary information reading unit 11b, an additional information file obtaining unit 11c, an additional information generation unit 11d, a video generation unit 11e, and a video reproduction unit 11f. FIG. 2 shows not only the video processing apparatus 11, but also the video camera 13, and the additional information file generation server 15.

The video processing apparatus 11 has a function as a computer. The video processing apparatus 11 is, for example, a communication apparatus, such as a personal computer, a smartphone, and a tablet terminal. The video processing apparatus 11 is supplied with a program from an internal or external recording device (not shown). The video processing apparatus 11 can execute the program recorded in the recording device and perform various processes. The video processing apparatus 11 executes the program recorded in the recording device to thereby function as the video obtaining unit 11a, the supplementary information reading unit 11b, the additional information file obtaining unit 11c, the additional information generation unit 11d, the video generation unit 11e, and the video reproduction unit 11f. The video processing apparatus 11 is, for example, a personal computer installed with an application including a program that causes the video processing apparatus 11 to function as the video obtaining unit 11a, the supplementary information reading unit 11b, the additional information file obtaining unit 11c, the additional information generation unit 11d, the video generation unit 11e, and the video reproduction unit 11f.

The video obtaining unit 11a obtains a video image file taken by the video camera 13. The supplementary information reading unit 11b detects a supplementary information tag recorded in the video image file obtained by the video obtaining unit 11a, and reads supplementary information. The additional information file obtaining unit 11c obtains the additional information file, based on the supplementary information read by the supplementary information reading unit 11b. Specifically, the additional information file obtaining unit 11c obtains the additional information file stored in the additional information file generation server 15, based on the supplementary information read by the supplementary information reading unit 11b.

The additional information generation unit 11d generates additional information from the additional information file obtained by the additional information file obtaining unit 11c. The video generation unit 11e superimposes the additional information generated by the additional information generation unit 11d, on the video image file obtained by the video obtaining unit 11a, and generates a video file combined with the additional information. The video reproduction unit 11f reproduces the video file combined with the additional information generated by the video generation unit 11e.

One Operation Example

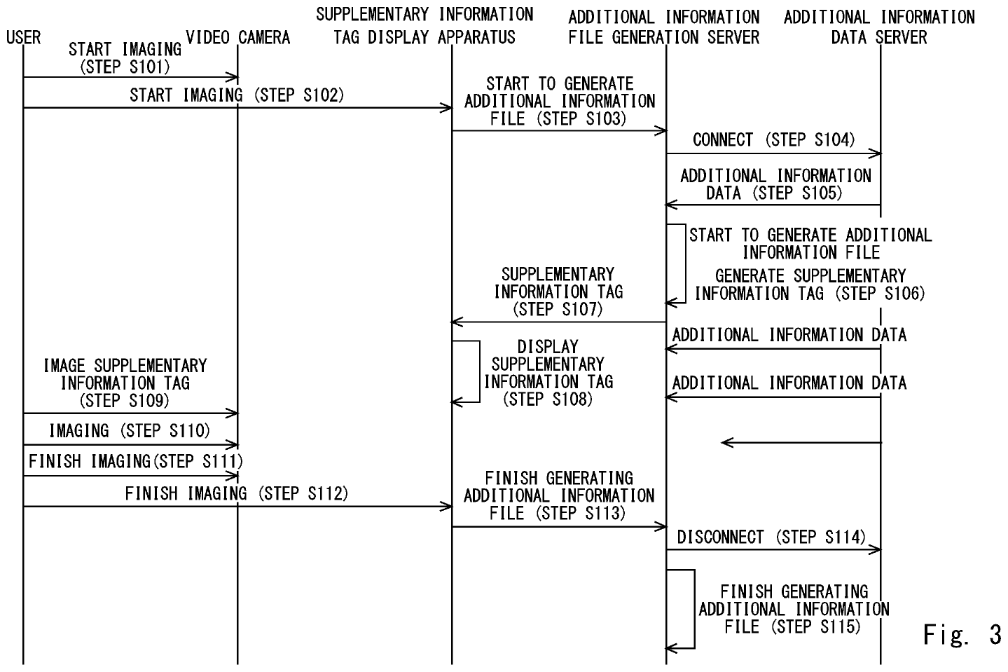

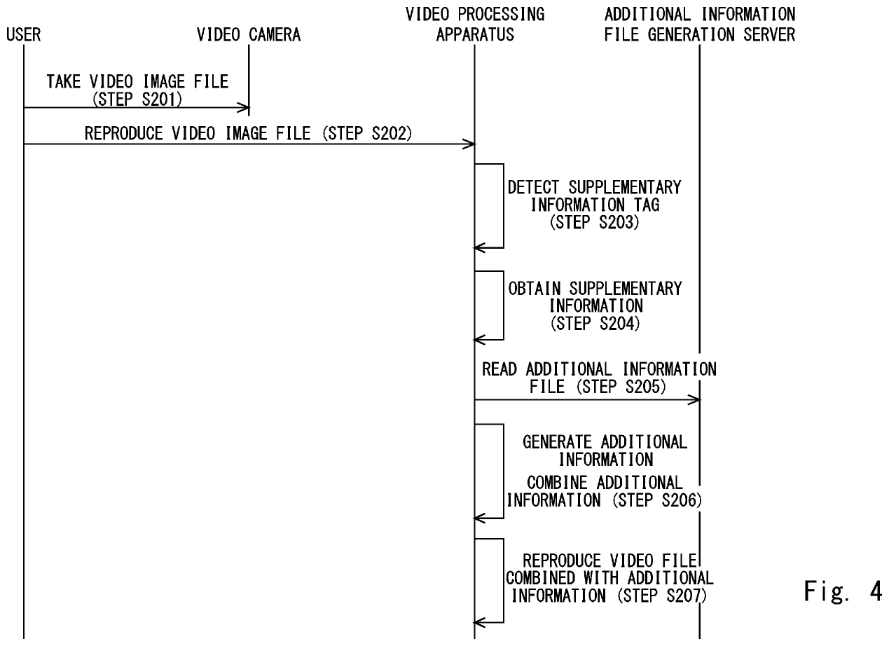

Next, referring to FIGS. 3 and 4, one operation example of the video processing system 1 is described. The video processing system 1 takes a video image using the video camera 13, and subsequently combines the video image with the additional information using the video processing apparatus 11, and reproduces the combined video image. FIG. 3 is a sequence chart showing one operation example during video imaging by the video processing system according to the first embodiment. FIG. 4 is a sequence chart showing one operation example during video reproduction by the video processing system according to the first embodiment.

When the video image is taken, first, the user operates the video camera 13 and starts to take the video image (step S101). The user performs step S101 and at the same time operates the trigger 12b that the supplementary information tag display apparatus 12 includes (step S102). When the trigger 12b is operated, the supplementary information tag display apparatus 12 instructs the additional information file generation server 15 to start to generate an additional information file (step S103).

Upon receipt of the instruction of starting to generate the additional information file, the additional information file generation server 15 is connected to the additional information data server 14 (step S104). The additional information data server 14 transmits additional information data to the additional information file generation server 15 (step S105). The additional information file generation server 15 starts to generate the additional information file on the basis of the additional information data received from the additional information data server 14, and generates a supplementary information tag from the supplementary information in the additional information file (step S106). The additional information file generation server 15 transmits the generated supplementary information tag to the supplementary information tag display apparatus 12 (step S107).

In the example shown in FIG. 3, the additional information data server 14 transmits the additional information data multiple times during connection to the additional information file generation server 15. Note that the number of transmissions of the additional information data by the additional information data server 14 is not specifically limited. The number may be plural or one. In the case where the additional information data server 14 transmits the additional information data multiple times, the additional information file generation server 15 generates the transmitted multiple additional information data items as one additional information file.

The supplementary information tag transmitted by the additional information file generation server 15 is displayed on the display unit 12a that the supplementary information tag display apparatus 12 includes (step S108). The user images the supplementary information tag displayed on the display unit 12a, using the video camera 13 (step S109). The user then images an imaging object using the video camera (step S110). The imaging object is not specifically limited, and can be appropriately selected by the user.

In the example shown in FIG. 3, after step S109 is performed, step S110 is performed. However, the order of performing steps S109 and S110 is not specifically limited. After step S110 is performed, step S109 may be performed. In the middle of performance of step S110, step S109 may be performed, and step S110 may be performed again.

After the user images the imaging object, they operate the video camera and finish imaging (step S111). After the user performs step S111, they operate the trigger 12b that the supplementary information tag display apparatus 12 includes (step S 112). When the trigger 12b is operated in step S112, the supplementary information tag display apparatus 12 instructs the additional information file generation server 15 to finish generating the additional information file (step S113). Upon receipt of the instruction of finishing generating the additional information file, the additional information file generation server 15 terminates the connection to the additional information data server 14 (step S114), and finishes generating the additional information file (step S115). The generated additional information file is saved in the additional information file generation server.

As described above, when the video image is taken using the video camera 13, the video processing system 1 can record the supplementary information tag in the video image file. Accordingly, after the video image is taken, the process of adding the supplementary information tag to the video image file is not required. Furthermore, the configuration for embedding the supplementary information tag in the video image file to video camera 13 is not required. Accordingly, the video camera 13 may be any video camera that has a video function.

FIG. 4 is a sequence chart showing one operation example during video reproduction by the video processing system according to the first embodiment. When the video is reproduced, first, the user takes the video image file from the video camera 13 (step S201). To start to reproduce the video image file, the user operates the video processing apparatus 11, and causes the video obtaining unit 11a to read the video image file taken from the video camera 13 (step S202). The video obtaining unit 11a obtains the video image file through the operation by the user in step S202.

Next, the supplementary information reading unit 11b detects the supplementary information tag recorded in the video image obtained by the video obtaining unit 11a (step S203), and reads the supplementary information tag and obtains the supplementary information (step S204). The additional information file obtaining unit 11c obtains the additional information file from the additional information file generation server 15, based on the supplementary information obtained by the supplementary information reading unit 11b (step S205). Next, the additional information generation unit 11d generates the additional information from the additional information file, and the video generation unit 11e superimposes the additional information on the video image file and generates a video file combined with the additional information (step S206). The video reproduction unit 11f reproduces the video file combined with the additional information generated by the video generation unit 11e (step S207).

As described above, the video processing apparatus 11 can obtain the additional information file from the supplementary information tag recorded in the video image, and superimpose the additional information on the video image file. The supplementary information tag is to be recorded in the video image. Accordingly, the amount of information that can be included is limited. On the other hand, the additional information file is to be stored in the additional information file generation server 15. Accordingly, this file may have a more amount of information than the supplementary information tag. Accordingly, for example, the video processing method using the video processing apparatus 11 can superimpose additional information having a more amount of information on the video image in comparison with the method of recording, in the video image, the bar code where the additional information is codified. As described above, in the video processing system 1, the video processing apparatus 11 is not required to be connected to the supplementary information tag display apparatus 12 during video reproduction.

### ONE MODIFICATION EXAMPLE

In the example shown in FIG. 3, the user performs steps S101 and S102 at the same time, thereby aligning the timings when the additional information is displayed in the video image. However, in a case where the lapse of time from start of generation of the additional information is embedded in the supplementary information tag, the timings when the additional information is displayed in the video image can be aligned with each other without performing steps S101 and S102 at the same time. Specifically, the supplementary information tag is periodically changed, that is, the supplementary information tag is changed every unit time period, and the lapse of time from start of generation of the additional information is embedded in the supplementary information tag. The unit time period is appropriately set without specific limitation. The unit time period is, for example, one second, 100 milliseconds, or the like. The video processing apparatus 11 calculates the additional information generation start time from the lapse of time embedded in the supplementary information tag, and aligns the timings when the additional information is displayed in the video image.

Note that the modification example described in the first embodiment can be implemented in a similar manner also in the following embodiments.

### Second Embodiment

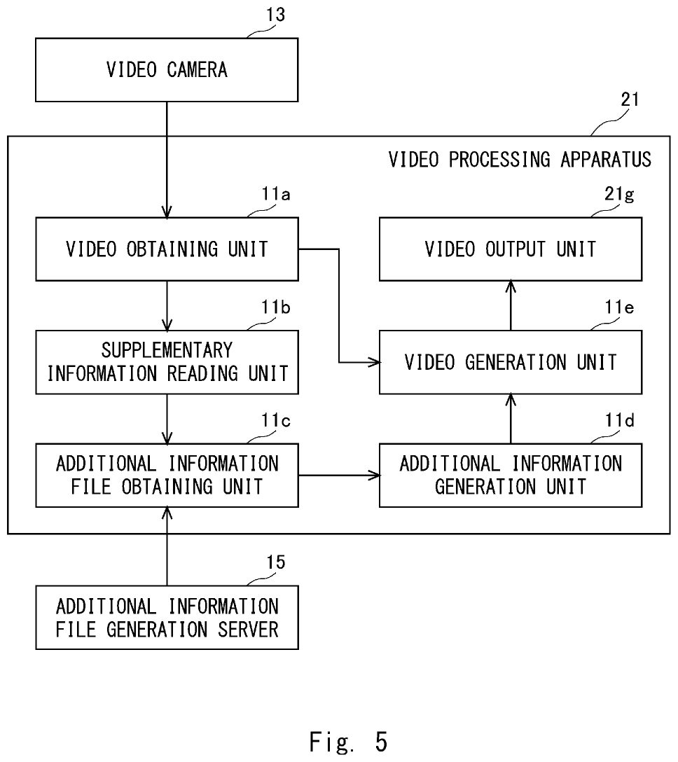

Next, referring to FIG. 5, the configurations of a video processing system and a video processing apparatus according to a second embodiment are described. FIG. 5 is a block diagram showing the configuration of the video processing apparatus and the peripheral configuration according to a second embodiment. The video processing system according to the second embodiment includes a video processing apparatus 21 shown in FIG. 5 instead of the video processing apparatus 11 shown in FIG. 1. The video processing apparatus 21 includes a video output unit 21g instead of the video reproduction unit 11f that the video processing apparatus 11 shown in FIG. 2 includes. The video output unit 21g outputs, to the outside, the video file combined with the additional information generated by the video generation unit 11e. The other components are similar to those described in the first embodiment. Accordingly, redundant description is appropriately omitted.

One Operation Example

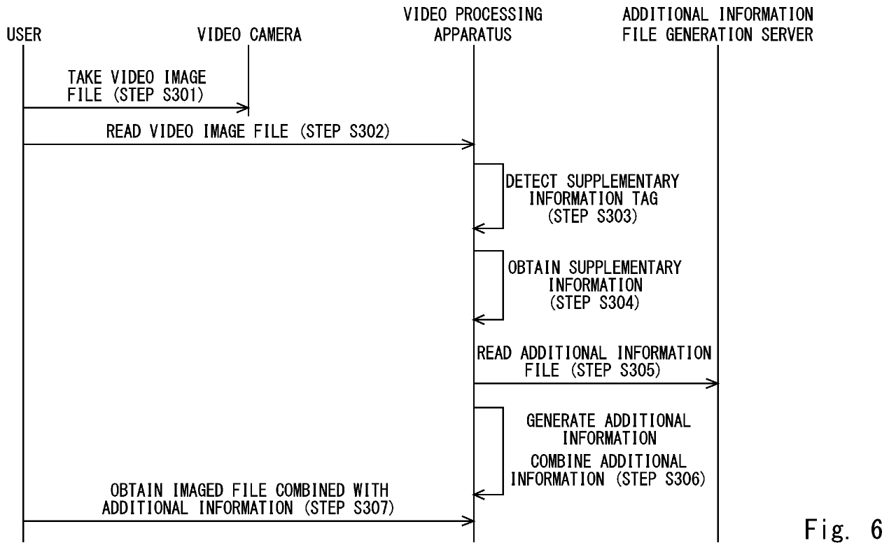

Referring to FIG. 6, one operation example of the video processing system according to the second embodiment is described. The video processing system according to the second embodiment takes a video image using the video camera 13, and subsequently combines the video image with the additional information using the video processing apparatus 21, and outputs the combined video image. The operation of the video processing system according to the second embodiment during video imaging is similar to the operation of the video processing system during video imaging according to the first embodiment. Accordingly, the description is omitted. FIG. 6 is a sequence chart showing one operation example during video output by the video processing system according to the second embodiment.

When the video is output, first, the user takes the video image file from the video camera 13 (step S301). To output the video image file, the user operates the video processing apparatus 21, and causes the video obtaining unit 11a to read the video image file taken from the video camera 13 (step S302). The video obtaining unit 11a obtains the video image file through the operation by the user in step S302.

Next, the supplementary information reading unit 11b detects the supplementary information tag recorded in the video image obtained by the video obtaining unit 11a (step S303), and reads the supplementary information tag and obtains the supplementary information (step S304).

The additional information file obtaining unit 11c obtains the additional information file stored in the additional information file generation server 15, based on the supplementary information obtained by the supplementary information reading unit 11b (step S305).

Next, the additional information generation unit 11d generates the additional information from the additional information file, and the video generation unit 11e superimposes the additional information on the video image file and generates a video file combined with the additional information (step S306). The video output unit 21g outputs the video file combined with the additional information generated by the video generation unit 11e. The user obtains the video file combined with the additional information output by the video output unit 21g (step S307). As described above, the video processing apparatus 21 can obtain the additional information file from the supplementary information tag recorded in the video image, and superimpose the additional information on the video image file.

### Third Embodiment

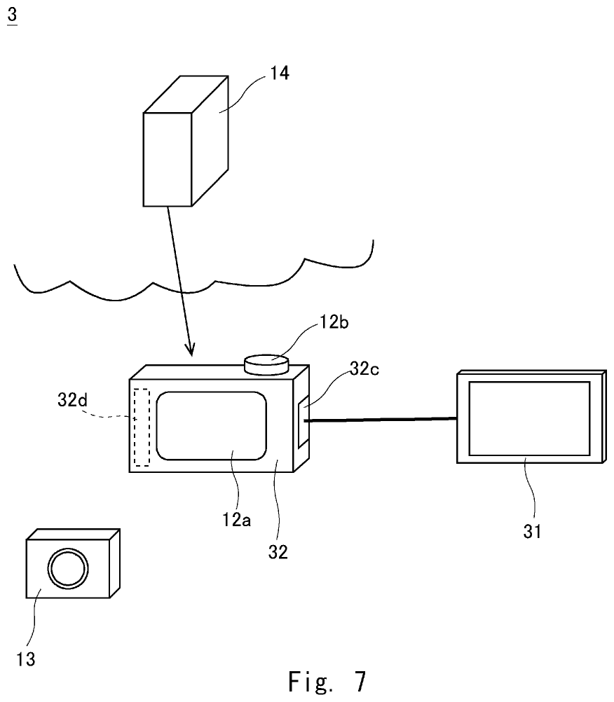

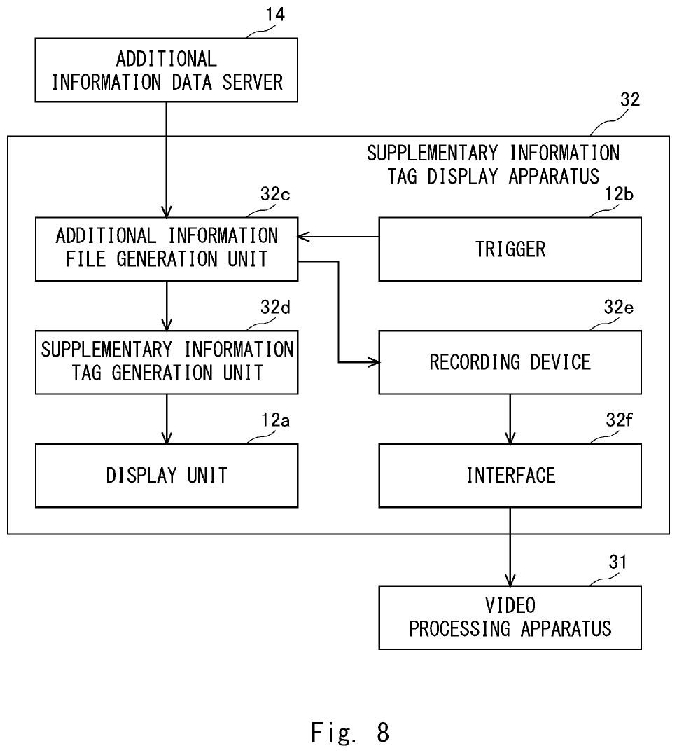

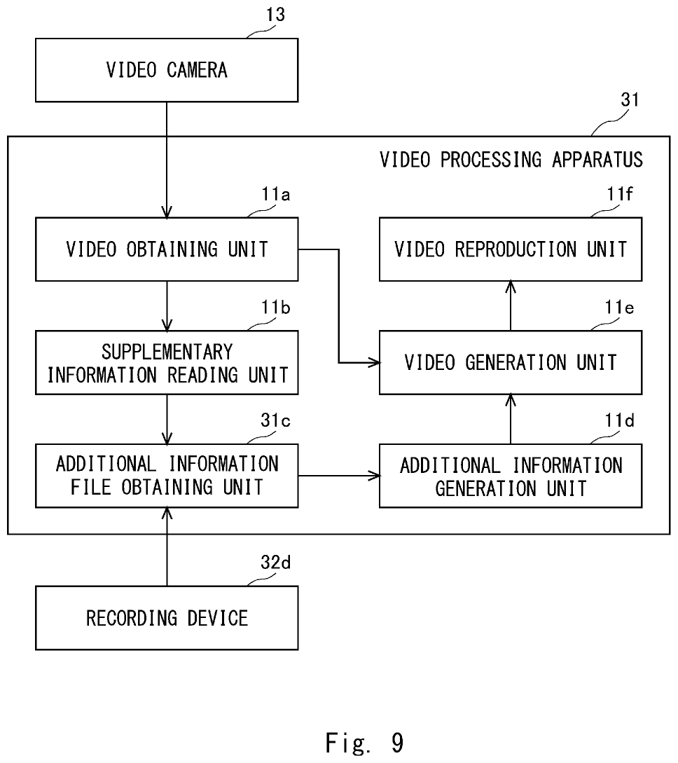

Next, referring to FIGS. 7 to 9, the configuration of a video processing system according to a third embodiment is described. FIG. 7 is an overall diagram showing the configuration of the video processing system according to the third embodiment. FIG. 8 is a block diagram showing the configuration of a supplementary information tag display apparatus and the peripheral configuration according to the third embodiment. FIG. 9 is a block diagram showing the configuration of the video processing apparatus and the peripheral configuration according to the third embodiment.

As shown in FIG. 7, the video processing system 3 includes a video processing apparatus 31, a supplementary information tag display apparatus 32, a video camera 13, and an additional information data server 14. The video processing system 3 includes the video processing apparatus 31 instead of the video processing apparatus 11 shown in FIG. 1. The video processing system 3 includes the supplementary information tag display apparatus 32 instead of the supplementary information tag display apparatus 12 shown in FIG. 1. Note that the video processing system 3 does not include the additional information file generation server 15 shown in FIG. 1. The other components are similar to those described in the first embodiment. Accordingly, redundant description is appropriately omitted.

As shown in FIG. 7, the supplementary information tag display apparatus 32 includes a recording device 32e and an interface 32f, in addition to the display unit 12a and the trigger 12b. As shown in FIG. 8, the supplementary information tag display apparatus 32 includes an additional information file generation unit 32c, and a supplementary information tag generation unit 32d, in addition to the components shown in FIG. 7. The additional information file generation unit 32c can receive additional information data from the additional information data server 14, and generate an additional information file.

The supplementary information tag generation unit 32d generates a supplementary information tag, from the supplementary information in the additional information file generated by the additional information file generation unit 32c. The display unit 12a displays the supplementary information tag generated by the supplementary information tag generation unit 32d so as to allow the video camera 13 to image the tag. The recording device 32e stores the additional information file generated by the additional information file generation unit 32c. The interface 32f connects the recording device 32e and the video processing apparatus 31 to each other.

As shown in FIG. 9, the video processing apparatus 31 includes a video obtaining unit 11a, a supplementary information reading unit 11b, an additional information file obtaining unit 31c, an additional information generation unit 11d, a video generation unit 11e, and a video reproduction unit 11f. The video processing apparatus 31 includes the additional information file obtaining unit 31c instead of the additional information file obtaining unit 11c that the video processing apparatus 11 includes. The additional information file obtaining unit 31c obtains the additional information file, based on the supplementary information read by the supplementary information reading unit 11b. Specifically, the additional information file obtaining unit 31c obtains the additional information file stored in the recording device 32e, based on the supplementary information read by the supplementary information reading unit 11b.

One Operation Example

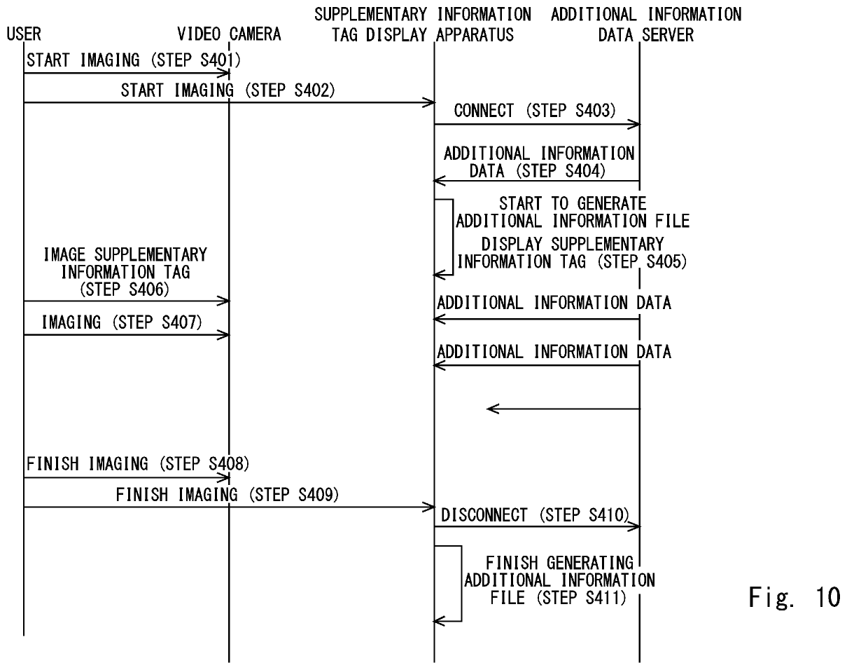

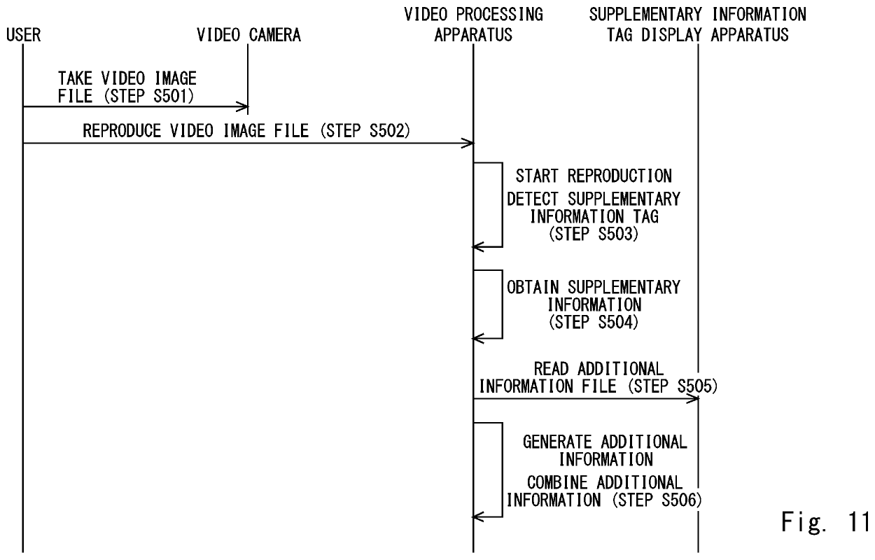

Next, referring to FIGS. 10 and 11, one operation example of the video processing system 3 is described. The video processing system 3 takes a video image using the video camera 13, and subsequently combines the video image with the additional information using the video processing apparatus 31, and reproduces the combined video image. FIG. 10 is a sequence chart showing one operation example during video imaging by the video processing system according to the third embodiment. FIG. 11 is a sequence chart showing one operation example during video reproduction by the video processing system according to the third embodiment.

When the video image is taken, first, the user operates the video camera 13 and starts to take the video image (step S401). The user performs step 5401 and at the same time operates the trigger 12b that the supplementary information tag display apparatus 32 includes (step S402). When the trigger 12b is operated, the additional information file generation unit 32c that the supplementary information tag display apparatus 32 includes is connected to the additional information data server 14 (step S403).

The additional information data server 14 transmits additional information data to the additional information file generation unit 32c (step S404). The additional information file generation unit 32c starts to generate an additional information file on the basis of the additional information data received from the additional information data server 14. The supplementary information tag generation unit 32d generates a supplementary information tag, from the supplementary information in the additional information file. The supplementary information tag generated by the supplementary information tag generation unit 32d is displayed on the display unit 12a (step S405). The user images the supplementary information tag displayed on the display unit 12a, using the video camera 13 (step S406). The user then images an imaging object using the video camera (step S407).

After the user images the imaging object, they operate the video camera and finish imaging (step S408). After the user performs step S408, they operate the trigger 12b that the supplementary information tag display apparatus 32 includes (step S409). When the trigger 12b is operated in step S409, the supplementary information tag display apparatus 12 terminates the connection to the additional information data server 14 (step S410), and finishes generating the additional information file (step S411). The generated additional information file is saved in the recording device 32e. As described above, when the video image is taken using the video camera 13, the video processing system 3 can record the supplementary information tag in the video image file.

FIG. 11 is a sequence chart showing one operation example during video reproduction by the video processing system according to the third embodiment. When the video is reproduced, first, the user takes the video image file from the video camera 13 (step S501). To start reproduction of the video image file, the user operates the video processing apparatus 31, and causes the video obtaining unit 11a to read the video image file taken from the video camera 13 (step S502). The video obtaining unit 11a obtains the video image file through the operation by the user in step S502.

Next, the supplementary information reading unit 11b detects the supplementary information tag recorded in the video image obtained by the video obtaining unit 11a (step S503), and reads the supplementary information tag and obtains the supplementary information (step S504). The additional information file obtaining unit 31c obtains the additional information file from the recording device 32e, based on the supplementary information obtained by the supplementary information reading unit 11b (step S505).

Next, the additional information generation unit 11d generates the additional information from the additional information file, and the video generation unit 11e superimposes the additional information on the video image file and generates a video file combined with the additional information (step S506). The video reproduction unit 11f reproduces the video file combined with the additional information generated by the video generation unit 11e (step S507). As described above, the video processing apparatus 11 can obtain the additional information file from the supplementary information tag recorded in the video image, and superimpose the additional information on the video image file.

The invention according to the embodiments described above can provide the video processing apparatus, the video processing method, the program, and the video processing system that can superimpose additional information having a more amount of information, on a video image.

Note that the present invention is not limited to the embodiments described above, and can be appropriately changed in a region without departing the spirit. For example, the aforementioned first, second and third embodiments have been described as separate embodiments. However, these first, second and third embodiments may be appropriately combined and implemented.

For example, in the embodiments described above, each of the components illustrated in the diagrams as functional blocks that perform various processes can be achieved by a CPU (Central Processing Unit), a memory, or another circuit in view of hardware, and can be achieved by a program or the like loaded on the memory in view of software. Accordingly, those skilled in the art understand that these functional blocks can be achieved in various forms only by hardware, only by software, or by a combination thereof. There is no limitation to any of them.

The program described above can be stored using any of various types of non-transitory computer readable medium, and can be supplied to a computer (a computer including an information notification device). The non-transitory computer readable medium encompasses various types of tangible storage media. Examples of the non-transitory computer readable medium include magnetic recording media (e.g., a flexible disk, a magnetic tape, and a hard disk drive), and magnetooptical recording media (e.g., a magnetooptical disk). The examples further include a CD-ROM (Read Only Memory), a CD-R, and a CD-R/W. The examples further include semiconductor memories (e.g., a mask ROM, a PROM (Programmable ROM), an EPROM (Erasable PROM), a flash ROM, and a RAM (Random Access Memory)). The program may be supplied to the computer through any of various types of transitory computer-readable medium. Examples of transitory computer-readable medium include an electric signal, an optical signal, and electromagnetic waves. The transitory computer-readable medium can supply the program to the computer via a wired communication path, such as an electric wire or an optical fiber, or a wireless communication path.

The present invention is preferably applicable to a video processing apparatus that edits an image taken by a video camera or the like.

What is claimed is:

1. A video processing system comprising a supplementary information tag output apparatus, and a video processing apparatus, wherein
the supplementary information tag output apparatus comprises
an output unit configured to output a supplementary information tag so as to allow a video camera to image the tag, the supplementary information tag including supplementary information in an additional information file, wherein
the supplementary information tag is recorded in a video image, by imaging the supplementary information tag output on the output unit when the video camera takes the video image.

2. The video processing system according to claim 1, wherein the output unit is an image output device configured to output an image, an audio signal output device configured to output an audio signal or an optical signal output device configured to output an optical signal.

3. The video processing system according to claim 1, wherein the video processing apparatus comprises:
a video obtaining unit configured to obtain the video image taken by the video camera;
a supplementary information reading unit configured to detect the supplementary information tag recorded in the video image obtained by the video obtaining unit, and read the supplementary information in the additional information file;
an additional information file obtaining unit configured to obtain the additional information file, based on the supplementary information read by the supplementary information reading unit; and
an additional information generation unit configured to generate additional information from the additional information file obtained by the additional information file obtaining unit.

4. The video processing system according to claim 3, further comprising a video generation unit configured to superimpose the additional information generated by the additional information generation unit, on the video image obtained by the video obtaining unit, and generate a video combined with the additional information.

5. The video processing system according to claim 4, further comprising a video reproduction unit configured to reproduce the video combined with the additional information generated by the video generation unit.

6. The video processing system according to claim 4, further comprising a video output unit configured to output, to an outside, the video combined with the additional information generated by the video generation unit.

7. The video processing system according to claim 3, wherein
the additional information file obtaining unit is connectable to an additional information file generation server that stores the additional information file, and
obtains the additional information file stored in the additional information file generation server, based on the supplementary information in the additional information file.

8. The video processing system according to claim 3, wherein
the additional information file obtaining unit is connectable to a recording device that stores the additional information file, and
obtains the additional information file stored in the recording device, based on the supplementary information in the additional information file.

9. A video processing method, comprising:
a step of obtaining a video image taken by a video camera;
a step of detecting a supplementary information tag recorded in the obtained video image, and reading supplementary information in an additional information file;
a step of obtaining the additional information file, based on the read supplementary information; and
a step of generating additional information from the obtained additional information file.

10. The video processing method according to claim 9, further comprising a step of superimposing the additional information on the video image, and generating a video combined with the additional information.

11. The video processing method according to claim 10, further comprising a step of reproducing the video combined with the additional information.

12. The video processing method according to claim 10, further comprising a step of outputting, to an outside, the video combined with the additional information.

13. The video processing method according to claim 9, further comprising a step of obtaining the additional information file stored in the additional information file generation server, based on the supplementary information in the additional information file.

14. The video processing method according to claim 9, further comprising a step of obtaining the additional information file stored in the recording device, based on the supplementary information in the additional information file.

15. A non-transitory computer readable medium storing program for causing a computer to execute:
a step of obtaining a video image taken by a video camera;
a step of detecting a supplementary information tag recorded in the obtained video image, and reading supplementary information in an additional information file;
a step of obtaining the additional information file, based on the read supplementary information; and
a step of generating additional information from the obtained additional information file.

16. The non-transitory computer readable medium according to claim 15, further causing a computer to execute a step of superimposing the additional information on the video image, and generating a video combined with the additional information.

17. The non-transitory computer readable medium according to claim 16, further causing a computer to execute a step of reproducing the video combined with the additional information.

18. The non-transitory computer readable medium according to claim 16, further causing a computer to execute a step of outputting, to an outside, the video combined with the additional information.

19. The non-transitory computer readable medium according to claim 15, further causing a computer to execute a step of obtaining the additional information file stored in the additional information file generation server, based on the supplementary information in the additional information file.

20. The non-transitory computer readable medium according to claim 15, further causing a computer to execute a step of obtaining the additional information file stored in the recording device, based on the supplementary information in the additional information file.
